(19) United States
(12) Patent Application Publication
(10) Pub. No.: US 2008/0252610 A1
(43) Pub. Date: Oct. 16, 2008

(54) Variably positionable touchpad interface

(76) Inventors: Mark S. Tracy, Tomball, TX (US); Paul J. Doczy, Cypress, TX (US); Jonathan R. Harris, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/786,301

(22) Filed: Apr. 11, 2007

(51) Int. Cl. G06F 3/041

(52) U.S. Cl. 345/173

(57) ABSTRACT

An electronic device comprises a touchpad module having at least one touchpad pick button rotatably coupled to a housing of the electronic device to enable movement of the at least one touchpad pick button between a non-extended position and an extended position relative to the housing.

### BACKGROUND

Electronic devices, such as notebook computers, tablet computers, personal digital assistants, gaming devices, etc., are sometimes provided in a small and/or ultra-lite configuration for easier portability of the electronic device (e.g., smaller size and less weight). However, because of the smaller size of the electronic device, various features of the electronic device are compromised. For example, smaller electronic devices generally have a smaller display screen and have less surface area for locating other features, such as interface features (e.g., particular function keys, a touchpad, lighted indicators, etc.).

### BRIEF DESCRIPTION OF THE DRAWINGS

FIGS. 1A and 1B are diagrams illustrating an electronic device in which an embodiment of a variably positionable touchpad interface is employed to advantage;

FIGS. 2A and 2B are diagrams illustrating a partial section view of the variably positionable touchpad interface of FIG. 1; and

FIGS. 3A and 3B are diagrams illustrating a partial section view of another embodiment of a variably positionable touchpad interface.

### DETAILED DESCRIPTION OF THE DRAWINGS

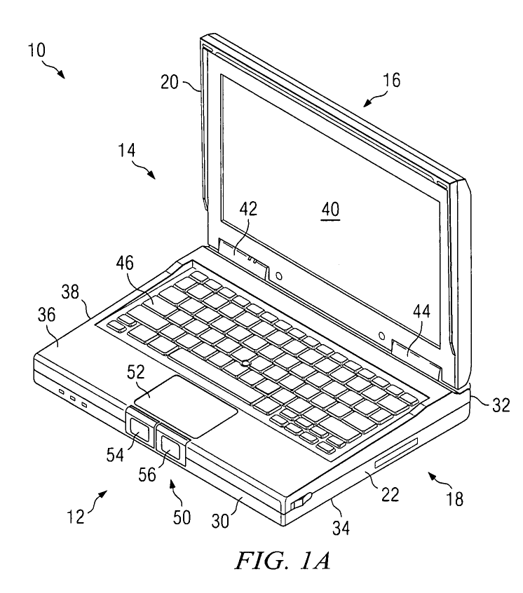

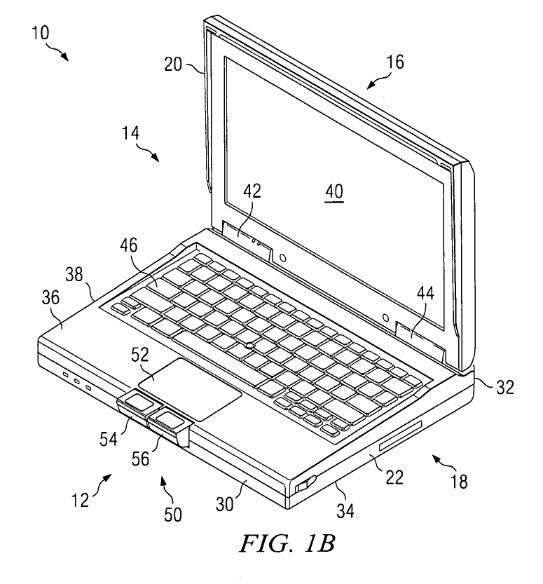

FIGS. 1A and 1B are diagrams illustrating an electronic device 10 in which an embodiment of a variably positionable touchpad interface 12 is employed to advantage. In the embodiment illustrated in FIGS. 1A and 1B, electronic device 10 comprises a notebook computer 14 having a display member 16 rotatably coupled to a base member 18. However, it should be understood that electronic device 10 may comprise other types of devices such as, but not limited to, a tablet computer, gaming device, personal digital assistant and media player device. In the embodiment illustrated in FIGS. 1A and 1B, display member 16 and base member 18 each comprise a housing 20 and 22, respectively, formed having a plurality of walls. For example, in FIGS. 1A and 1B, housing 22 comprises a front wall 30, a rear wall 32, a bottom wall 34, an upper wall or deck forming a working surface 36 and a plurality of side walls 38 and 40. In FIGS. 1A and 1B, housing 20 of display member 16 supports and/or otherwise surrounds a display screen 40 for outputting visual content using electronic device 10.

In FIGS. 1A and 1B, display member 16 is rotatably coupled to base member 18 via hinges 42 and 44. However, it should be understood that electronic device 10 may be otherwise configured. For example, in some embodiments, electronic device 10 may be configured as a convertible notebook computer 14 such that display member 16 is pivotable and/or rotatable about at least two different axes to facilitate use of notebook computer 14 in either a notebook mode (e.g., as illustrated in FIGS. 1A and 1B where display screen 40 is positioned to face working surface 36) or a tablet mode (e.g., where a display screen 40 may be positioned to face away from working surface 36 when display member 16 is disposed in a closed position relative to base member 18). As used herein, a “closed position” shall mean when display member 16 is located in a position substantially parallel and/or coplanar with base member 18 such that display member 16 is disposed in contact with or directly adjacent to working surface 36 and/or a keyboard 46 of electronic device 10 regardless of the direction display screen 40 is facing.

In the embodiment illustrated in FIGS. 1A and 1B, touchpad interface 12 comprises a touchpad module 50 for receiving user input to electronic device 10. In FIGS. 1A and 1B, touchpad module 50 comprises a touchpad 52 and a plurality of touchpad pick buttons 54 and 56. For example, in some embodiments, touchpad 52 is configured to receive input via a user's finger, a stylus or other instrument (e.g., in the form of contact-based translational movement), and touchpad pick buttons 54 and 56 are actuatable and/or otherwise used to select and/or otherwise enter a particular input associated with touchpad 52 (e.g., such as left-click and right-click mouse buttons). In the embodiment illustrated in FIGS. 1A and 1B, touchpad pick buttons 54 and 56 are rotatably coupled to housing 22 to facilitate rotatable and/or pivotal movement of touchpad pick buttons 54 and 56 relative to housing 22, thereby enabling touchpad pick buttons 54 and 56 to be moved between a retracted and/or non-extended position (FIG. 1A) and an extended position (FIG. 1B) relative to housing 22. In the embodiment illustrated in FIGS. 1A and 1B, two touchpad pick buttons 54 and 56 are illustrated. However, it should be understood that a greater or fewer quantity of touchpad pick buttons may be used. Further, in FIGS. 1A and 1B, touchpad module 50 (e.g., touchpad 52 and touchpad pick buttons 54 and 56) is located on base member 18. However, it should be understood that touchpad module 50 may be otherwise located on electronic device 10 (e.g., alternatively or additionally on display member 16).

In some embodiments, when touchpad pick buttons 54 and 56 are located in a non-extended position (FIG. 1A), touchpad pick buttons 54 and 56 are located within an outer perimeter or profile of base member 18 and/or housing 22. However, it should be understood that in some embodiments, when touchpad pick buttons 54 and 56 are located in a non-extended position, touchpad pick buttons 54 and 56 may extend slightly outwardly of a profile of base member 18 and/or housing 22. Further, in some embodiments, when touchpad pick buttons 54 and 56 are located in an extended position (FIG. 1B), at least a portion of touchpad pick buttons 54 and 56 extend outwardly beyond a perimeter or profile of housing 22. In some embodiments, touchpad pick buttons 54 and 56 are useable and/or configurable to receive and communicate input to electronic device 10 while in the extended position or the non-extended position. For example, in some embodiments, for ergonomic reasons or otherwise, a user of electronic device 10 may desire to use touchpad module 50 with touchpad pick buttons 54 and 56 in a non-extended position (e.g., using touchpad pick buttons 54 and 56 while located in a position parallel or coplanar (parallel or substantially parallel) with front wall 30 of housing 22) where the non-extended position corresponds to a comfortable or natural position of a user's thumb when using electronic device 10. However, in other instances, a user may desire to utilize touchpad module 50 having touchpad pick buttons 52 and 54 flipped outwardly and/or upwardly to a position parallel or coplanar (parallel or substantially parallel) with working surface 36 and/or touchpad 52. Thus, it should be understood that electronic device 10 may be configured to enable use of touchpad pick buttons 52 and 54 while touchpad pick buttons 52 and 54 are located in a non-extended position or extended position.

Further, in some embodiments, interface 12 is configured to facilitate receipt and communication of input by touchpad pick buttons 54 and 56 even while display member 16 is in a closed position relative to base member 18 with touchpad pick buttons 54 and 56 in either an extended or non-extended position. For example, in some embodiments, a user may desire to use electronic device 10 while display member 16 is in a closed position relative to base member 18 (e.g., in a tablet mode of operation or in a non-tablet mode of operation, such as using electronic device 10 to output audio content while display member 16 is in a closed position relative to base member 18). Thus, in some embodiments, electronic device 10 and/or interface 12 is configured to enable receipt and communication of input received by touchpad pick buttons 54 and 56 in either extended or non-extended positions regardless of a position of display member 16 relative to base member 18. In FIGS. 1A and 1B, touchpad pick buttons 54 and 56 are illustrated as being either both in an extended position or both in a non-extended position. However, it should be understood that touchpad pick buttons 54 and 56 may be configured to be moved independently of each other (e.g., touchpad pick button 54 in an extended position while touchpad pick button remains in a non-extended position, and vice versa). It should also be understood that in some embodiments, touchpad pick buttons 54 and 56 may be coupled together in a manner such that touchpad pick buttons 54 and 56 are movable together as a unit.

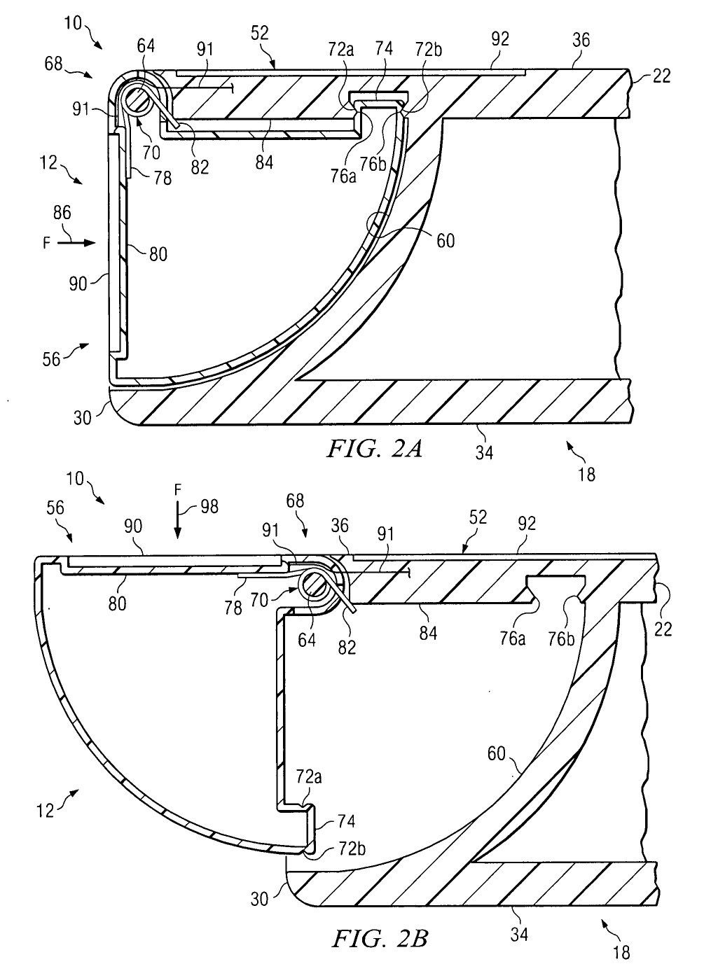

FIGS. 2A and 2B are diagrams illustrating a partial section view of interface 12 of FIGS. 1A and 1B. In FIG. 2A, touchpad pick button 56 is illustrated in a retracted or non-extended position relative to housing 22, and FIG. 2B illustrates touchpad pick button 56 in an extended position relative to housing 22. In FIGS. 2A and 2B, interface 12 is described in connection with touchpad pick button 56; however, it should be understood that touchpad pick button 54 and the operation thereof may be similarly configured. In the embodiment illustrated in FIGS. 2A and 2B, housing 22 comprises a recessed area or a cavity 60 for receiving touchpad pick button 56 therein. For example, in FIGS. 2A and 2B, cavity 60 is disposed along front wall 30 of housing 22 such that in a non-extended position (FIG. 2A), touchpad pick button 56 is disposed within the outer perimeter or profile of housing 22. In the embodiment illustrated in FIGS. 2A and 2B, touchpad pick button 56 is pivotally or rotatably coupled to housing 22 via a hinge 64. However, it should be understood that touchpad pick button 56 may be rotatably coupled to housing 22 using other methods or devices.

In FIGS. 2A and 2B, interface 12 comprises a locking mechanism 68 for releasably securing touchpad button 56 in a plurality of different positions relative to housing 22. In the embodiment illustrated in FIGS. 2A and 2B, locking mechanism 68 comprises a torsion spring 70, a pair of recesses 72a and 72b formed on an internal extension 74 of touchpad pick button 56, and a pair of corresponding extensions 76a and 76b formed in housing 22 near a rearward portion of cavity 60. In operation, recesses 72a and 72b are configured to cooperate with corresponding extensions 76a and 76b to releasably secure touchpad pick button 56 in a non-extended position (FIG. 2A). Torsion spring 70 comprises a leg 78 disposed against an interior surface 80 of touchpad pick button 56 and a leg 82 disposed against an interior surface 84 of housing 22. In operation, torsion spring 70 exerts a biasing force on touchpad pick button 56 to bias touchpad pick button 56 outwardly from cavity 60 and/or toward an extended position relative to housing 22. In some embodiments of operation, to release and/or otherwise extend touchpad pick button 56, a force F is applied in the direction indicated by arrow 86 to move touchpad pick button 56 slightly inwardly to overcome the retention force between recesses 72a and 72b and extensions 76a and 76b, respectively. In response to a release of force F, torsion spring 70 exerts a biasing force on touchpad pick button 56 which, together with some initial movement of touchpad pick button 56 before recesses 72a and 72b encounter extension 76a and 76b, respectively, causes touchpad pick button 56 to extend outwardly from cavity 60 (e.g., causing a sufficient level of outward momentum to overcome the retention force between recesses 72a and 72b and respective extensions 76a and 76b). Thus, in some embodiments of operation, locking mechanism 68 operates as a type of push-push locking mechanism to facilitate a release of touchpad pick button 56 from cavity 60. However, it should be understood that other methods and/or elements may be used to releasably secure touchpad pick button 56 in one or more locations relative to housing 22.

In some embodiments, hinge 64 is configured having a limited amount of angular rotation, thereby limiting an amount of rotation of touchpad pick button 56 and/or otherwise limiting an amount of outward movement of touchpad pick button 56. For example, in some embodiments, hinge 64 is configured to have a limited amount of angular rotation such that touchpad pick button 56 rotates outwardly relative to housing 22 to a maximum extended position, such as that illustrated in FIG. 2B. However, it should be understood that touchpad pick button 56 and/or locking mechanism 68 may be otherwise configured to secure touchpad pick button 56 at particular locations relative to housing 22. To return touchpad pick button 56 to a non-extended position (FIG. 2A) from an extended position (FIG. 2B), a force F may be applied to touchpad pick button 56 in the direction indicated by arrow 98 to overcome the biasing force applied by torsion spring 70 until recesses 72a and 72b are aligned with and/or otherwise engaged extensions 76a and 76b, thereby securing touchpad pick button 56 in a non-extended position.

In FIG. 2A, touchpad pick button 56 is located in a non-extended position such that a position of an input interface 90 of touchpad pick button 56 is located parallel or coplanar (parallel or substantially parallel) to front wall 30 and perpendicular (perpendicular or substantially perpendicular) to working surface 36 and/or an input interface 92 of touchpad 52. Referring to FIG. 2B, in at least one extended position of touchpad pick button 56 relative to housing 22 (e.g., in some embodiments, a fully extended position), input interface 90 of touchpad pick button 56 is located parallel or coplanar (parallel or substantially parallel) to working surface 36 and/or input interface 92 of touchpad 52. However, it should be understood that the range of motion and/or relative positions of input interfaces 90 and 92 of interface 12 may be otherwise configured. In the embodiment illustrated in FIGS. 2A and 2B, a cable 91 or other type of communicative membrane or conduit is communicatively coupled to and extends from touchpad pick button 56 to an interior area of electronic device 10 to facilitate communication of input received thereby. Cable 91 may be routed through and/or around hinge 64 or otherwise to facilitate communicative input received by touchpad pick button 56 to a keyboard controller or other device of electronic device 10 configured to receive such input.

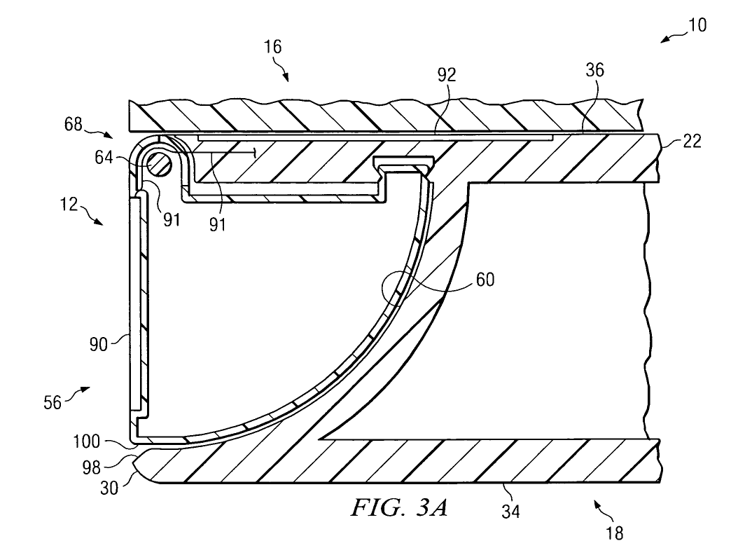

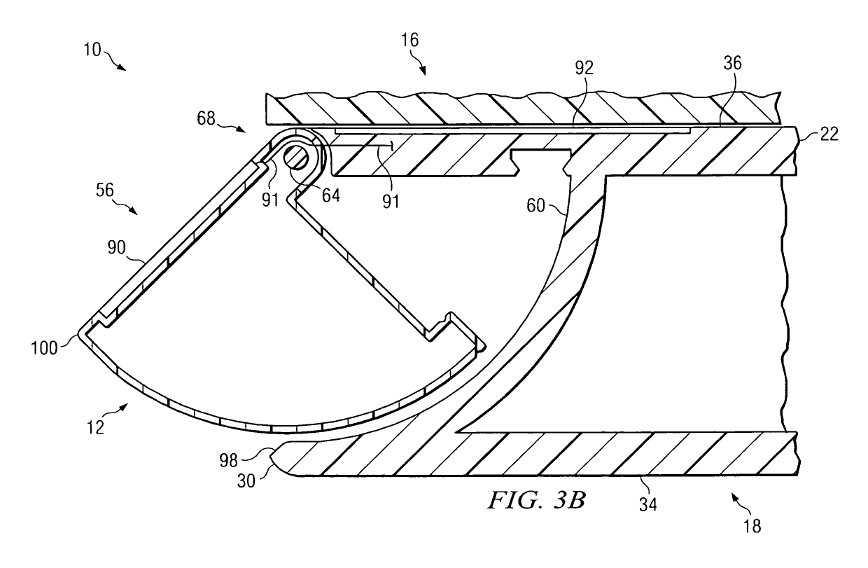

FIGS. 3A and 3B are diagrams illustrating a partial section view of another embodiment of interface 12. In the embodiment illustrated in FIGS. 3A and 3B, locking mechanism 68 comprises hinge 64 configured as a clutch- and/or ratchet-based hinge 64 such that touchpad pick button 56 is securable at a plurality of different extended positions relative to housing 22. For example, referring to FIG. 3B, touchpad pick button 56 is illustrated in a partially extended position (based on a fully extended position being a position such as that illustrated in FIG. 2B or at least a position further extended beyond that illustrated in FIG. 3B). In some embodiments of operation, hinge 64 enables touchpad pick button 56 to be releasably secured in a plurality of different angular positions relative to working surface 36 and/or front wall 30 of housing 22. Thus, embodiments of interface 12 enable variable positioning of touchpad pick button 56 relative to housing 22 based on an ergonomically desired position for touchpad pick 56. In the embodiment illustrated in FIGS. 3A and 3B, display member 16 is shown in a closed position relative to base member 18. As described above, it should be understood that input interface 90 of touchpad pick button 56 is configurable to receive and communicate input to electronic device 10 when display member 16 is disposed in a closed position relative to base member 18 while touchpad pick button 56 is disposed in a non-extended position (FIG. 3A) or an extended position, partially or otherwise (FIG. 3B).

In the embodiment illustrated in FIGS. 3A and 3B, housing 22 comprises a recessed portion 98 disposed along front wall 30 of housing 22 to facilitate engagement of touchpad pick button 56 by a user to draw touchpad pick button 56 outwardly from cavity 60 to a desired extended position. For example, in some embodiments of operation, recessed portion 98 enables a user's finger to engage a bottom portion 100 of touchpad pick button 56 (as best illustrated in FIG. 3A) to facilitate movement of touchpad pick button 56 outwardly from cavity 60. However, it should be understood that interface 12 and/or housing 22 may be otherwise configured to facilitate extension of touchpad pick button 56 from cavity 60. For example, in some embodiments, electronic device 10 may be configured with a release button or other mechanism for automatically causing touchpad pick button 56 to extend at least slightly outwardly from cavity 60 to facilitate further outward movement thereof by a user.

Thus, embodiments of interface 12 enable variable positioning of touchpad pick buttons 54 and/or 56 to an ergonomically desirable position. Further, embodiments of interface 12 enable touchpad pick buttons 54 and/or 56 to be located in either a non-extended position or one or more different extended positions, thereby providing increased flexibility for using and/or storing touchpad pick buttons 54 and 56 with devices having small form factors.

What is claimed is:

1. An electronic device, comprising:
a touchpad module having at least one touchpad pick button rotatably coupled to a housing of the electronic device to enable movement of the at least one touchpad pick button between a non-extended position and an extended position relative to the housing.

2. The electronic device of claim 1, wherein the at least one touchpad pick button is configured to communicate received input in the non-extended position.

3. The electronic device of claim 1, wherein an input interface of the at least one touchpad pick button is positionable parallel to a working surface of the electronic device when the at least one touchpad pick button is disposed in the extended position.

4. The electronic device of claim 1, wherein an input interface of the at least one touchpad pick button is positionable parallel to an input interface of a touchpad of the touchpad module when the at least one touchpad pick button is disposed in the extended position.

5. The electronic device of claim 1, wherein the at least one touchpad pick button is biased toward the extended position.

6. The electronic device of claim 1, further comprising a locking mechanism configured to secure the at least one touchpad pick button in the non-extended position.

7. The electronic device of claim 1, wherein the at least one touchpad pick button is releasably securable in either of the extended and the non-extended positions.

8. The electronic device of claim 1, wherein the at least one touchpad pick button is coupled to the housing via a hinge.

9. The electronic device of claim 1, wherein the at least one touchpad pick button is releasably securable in a plurality of different extended positions relative to the housing.

10. An electronic device, comprising:
means for receiving touchpad input to the electronic device; and
means for rotatably coupling the touchpad input means to a housing of the electronic device to enable movement of the touchpad input means between a non-extended position and an extended position relative to the housing means.

11. The electronic device of claim 10, wherein the rotatably coupling means comprises means for releasably securing the touchpad input means in a plurality of different extended positions relative to the housing.

12. The electronic device of claim 10, wherein an interface means of the touchpad input means is positionable parallel with a working surface of the electronic device in the extended position.

13. The electronic device of claim 10, wherein the touchpad input means is configured to communicate received input in the non-extended position.

14. The electronic device of claim 10, wherein an interface means of the touchpad input means is releasably securable in at least two different planes perpendicular to each other.

15. An electronic device, comprising:
a display member rotatably coupled to a base member to enable positioning of the display member in a closed position relative to the base member; and
at least one touchpad pick button actuatable when the display member is in the closed position relative to the base member.

16. The electronic device of claim 15, wherein the at least one touchpad pick button is variably positionable relative to the base member.

17. The electronic device of claim 15, wherein an input interface of the at least one touchpad pick button is locatable in a position perpendicular to the display member when the display member is in the closed position relative to the base member.

18. The electronic device of claim 15, wherein the at least one touchpad pick button is rotatably coupled to the electronic device.

19. The electronic device of claim 15, wherein the at least one touchpad pick button is rotatably coupled to the base member.

20. The electronic device of claim 15, wherein the at least one touchpad pick button is coupled to the electronic device by a hinge.

21. An electronic device, comprising:
a touchpad having at least one touchpad pick button associated therewith, the touchpad pick button rotatably coupled to the electronic device to enable variable positioning of the at least one touchpad pick button relative to the electronic device.

22. The electronic device of claim 21, wherein the at least one touchpad pick button is releasably securable in a plurality of different positions relative to the electronic device.

23. The electronic device of claim 21, wherein an input interface of the at least one touchpad pick button is securable in at least two different planes perpendicular to each other.

24. The electronic device of claim 21, wherein the at least one touchpad pick button is coupled to the electronic device by a hinge.

25. An electronic device, comprising:
a housing having at least one touchpad pick button rotatably coupled thereto, the at least one touchpad pick button rotatably movable to extend outwardly from a cavity of the housing.

26. The electronic device of claim 25, wherein the at least one touchpad pick button is configured to communicate received input while disposed in the cavity.

27. The electronic device of claim 25, wherein the at least one touchpad pick button is movable from the cavity to position an input interface of the at least one touchpad pick button parallel to an input interface of a touchpad of the electronic device.

28. The electronic device of claim 25, wherein the electronic device comprises a notebook computer.
